(19) United States
(12) Patent Application Publication
(10) Pub. No.: US 2006/0291658 A1
(43) Pub. Date: Dec. 28, 2006

(54) Portable terminal having function of coupling and reproducing multimedia files and method thereof

(75) Inventors: Seung-Yoon Baek, Seoul (KR); Joon-Young Jang, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Pantech&Curitel Communications, Inc.

(21) Appl. No.: 11/448,445

(22) Filed: Jun. 6, 2006

(30) Foreign Application Priority Data
Jun. 28, 2005 (KR) 10-2005-0056529

(51) Int. Cl. H04L 9/32; H04N 7/16; G06F 12/14; H04K 1/00; G06F 17/30; G06F 7/04; G06F 11/30; G06K 9/00; H03M 1/68; H04L 9/00

(52) U.S. Cl. 380/270; 713/193; 726/27; 726/28; 726/29

(57) ABSTRACT

A portable terminal having a function of coupling and reproducing a plurality of multimedia files and a method thereof are disclosed. The portable terminal includes: a storing unit for storing a plurality of multimedia files each of which has time information; an input unit for receiving a request signal of coupling and reproducing of the plurality of multimedia files; a controller for coupling the plurality of multimedia files to single integrated multimedia when the request signal of coupling and reproducing is received through the input unit; and an output unit for outputting the single integrated multimedia file in response to the controller.

### FIELD OF THE INVENTION

The present invention relates to a portable terminal having a function of coupling and reproducing multimedia files and a method thereof; and, more particularly, to a portable terminal having a function of coupling a plurality of multimedia files as single file and reproducing the coupled file in order to improve convenience for watching images, and a method thereof.

### DESCRIPTION OF RELATED ARTS

A portable terminal is a terminal having a function of storing multimedia files and reproducing the multimedia files. The portable terminal may be a wireless communication terminal, a digital camera, a camcorder and a portable multimedia player (PMP).

A wireless communication terminal is a portable terminal capable of transmitting/receiving voice, text and image data through a wireless communication network. Such a wireless communication terminal may be a mobile communication terminal, a personal communication service (PCS) terminal, a personal digital assistant (PDA), a smart phone, a next generation mobile terminal for IMT-2000, and a wireless local area network (LAN) terminal.

Hereinafter, a wireless communication terminal is used as an example of the portable terminal to describe the present invention.

According to development of wireless data communication technology and image processing technology, a wireless communication terminal is often used to transmit, receive, acquire and store multimedia files. For example, an internal or external camera module of the wireless communication terminal is used to photograph moving pictures or still images, and store the photographed moving pictures or still images. Also, such acquired moving pictures or still images may be transmitted to other terminal using a communication managing server such as a multimedia messaging server.

Source data of multimedia file occupies large amount of storage space. Accordingly, the wireless communication terminal generally has an encoder or a decoder to smoothly transmit/receive multimedia files and to reduce the storage space.

Hereinafter, operations of the encoder for compressing the source data and the decoder for decompressing the compressed data are described with reference to FIG. 1.

FIG. 1 is a block diagram for describing an encoding operation and a decoding operation in accordance with the related art.

As shown in FIG. 1, the encoding operation includes a discrete cosine transformation (DCT) operation 11, a quantization operation 12 and an entropy encoding operation 13 as an encoder.

In the DCT operation 11, a discrete cosine transformation (DCT) is performed on the source data, which is an original data, to divide each block of the source data to cosine functions having different frequency components. That is, image of space domain is transformed to frequency domain. Herein, a basic color of corresponding block is expressed as DC coefficient and information about color variation between each of pixels is expressed as AC coefficient.

In the quantization operation 12, a quantization is performed on the transformed data to eliminate a predetermined portion of the transformed data as much as not to be recognized by human's sight. According to a target quality of the image, amount of eliminated portion for AC coefficient information is decided. That is, a high-quality image is generated with less eliminated portion and includes large AC coefficients.

In the entropy encoding operation 13, an image is compressed using an entropy encoding scheme such as Huffman coding, and the compressed data is finally generated. Herein, the compressed data includes a header and a data, and the header has a sampling rate.

Meanwhile, an entropy decoding operation 14, an inverse-quantization operation 15 and an inverse discrete cosine transformation operation 15 are orderly performed to recover the compressed data to the original data in the decoding operation shown in FIG. 1. Such an encoding and a decoding operation are performed on each of multimedia files selected by a user.

Meanwhile, when a user watches a plurality of multimedia files using a wireless communication terminal, the user must select each of the multimedia files and reproduce the selected one of the multimedia files, repeatedly. For example, if the wireless communication terminal stores 10 multimedia files each of which has 10 seconds as a running time, the user selects each of 10 multimedia files by clicking each multimedia file, and independently reproduces each of the multimedia files. It is very annoying process to a user.

Especially, when a user wants to watch a set of multimedia files having a same theme such as wedding pictures, the user must select each of multimedia files and independently reproduce the selected multimedia files, repeatedly. Therefore, there is a great demand of continuously reproducing a set of multimedia files having a same theme without independently selecting and reproducing the multimedia files.

### SUMMARY OF THE INVENTION

It is, therefore, an object of the present invention to provide a portable terminal having a function of coupling and reproducing multimedia files, and a method thereof for improving user's convenience of watching images by coupling a plurality of multimedia files according to time information included in each multimedia file after decoding each of multimedia files such as image files, generating single integrated multimedia file, and reproducing the single integrated multimedia file.

In accordance with an aspect of the present invention, there is provided a wireless communication terminal including: a storing unit for storing a plurality of multimedia files each of which has time information; an input unit for receiving a request signal of coupling and reproducing of the plurality of multimedia files; a controller for coupling the plurality of multimedia files to single integrated multimedia when the request signal of coupling and reproducing is received through the input unit; and an output unit for outputting the single integrated multimedia file in response to the controller.

In accordance with an aspect of the present invention, there is also provided a method of coupling and reproducing a plurality of multimedia files in a portable terminal, including: inputting a request signal of coupling and reproducing a plurality of multimedia files; coupling the plurality of multimedia files according to the time information assigned to each of the multimedia files as single multimedia file; and reproducing the single multimedia file.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a block diagram for describing an encoding operation and a decoding operation in accordance with the related art;

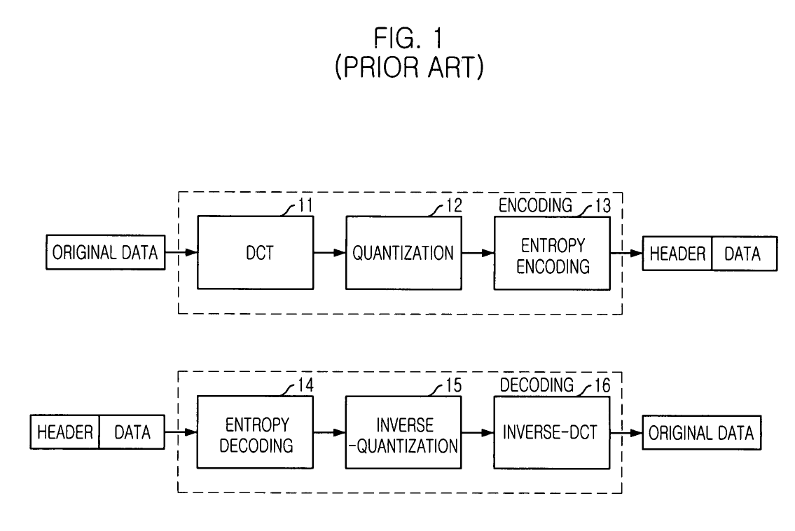

FIG. 2 is a block diagram illustrating a wireless communication terminal having a function of coupling and reproducing a plurality of multimedia files in accordance with a preferred embodiment of the present invention; and

FIG. 3 is a flowchart showing a method of coupling and reproducing a plurality of multimedia files in accordance with a preferred embodiment of the present invention.

### DETAILED DESCRIPTION OF THE INVENTION

Hereinafter, a portable terminal having a function of coupling and reproducing multimedia files and a method thereof will be described in more detail with reference to the accompanying drawings.

A portable terminal according to the present invention orderly couples a plurality of multimedia files according to time information included in each file after decoding encoded multimedia files, i.e., image files to create single image file. Therefore, a use can consecutively watch the plurality of multimedia files by reproducing the created singe image file. Herein, the time information is inserted into each of the multimedia files when a plurality of the multimedia files is encoded and stored.

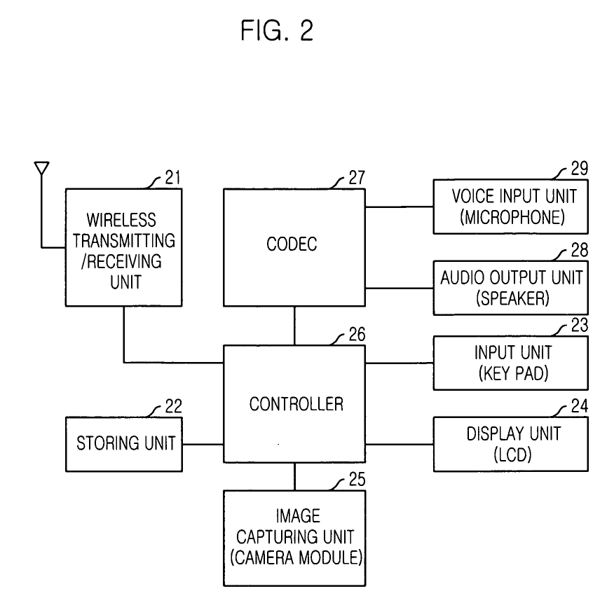

FIG. 2 is a block diagram illustrating a wireless communication terminal having a function of coupling and reproducing a plurality of multimedia files in accordance with a preferred embodiment of the present invention.

As shown in FIG. 2, the wireless communication terminal according to the present embodiment includes: a wireless transmitting/receiving unit 21 for transmitting and receiving signals through a wireless communication network to/from external devices; a storing unit 22 for storing a plurality of multimedia files each of which has time information and various programs; an input unit 23 such as a key pad for receiving a request signal to couple or to reproduce the multimedia files; a display unit 24 such as a liquid crystal display unit (LCD) for outputting a user interface and information on a screen in response to control of a controller 26; an image capturing unit 25 such as a camera module for capturing an image of an object in response to a control of the controller 26; the controller 26 for generally controlling elements of the wireless communication terminal for receiving the request signals of coupling the multimedia files and reproducing the coupled multimedia files, decoding each of the multimedia files selected according to the request signals, coupling the decoded multimedia files into single integrated multimedia file according to the time information assigned to each of the multimedia files, and reproducing the single integrated multimedia file; an audio output unit 28 such as a speaker for converting signals transferred from the wireless transmitting/receiving unit 21 to a voice and outputting the voice; a CODEC 27 for converting a voice from the voice input unit 29 such as a microphone to a signal, transferring the converted signal to the controller 26 to transmit the converted signal through the wireless transmitting/receiving unit 21; a voice output unit for outputting the voice transferred from the CODEC 27; and a voice input unit 29 such as a microphone for receiving a voice and transferring the voice to the CODEC 27.

Herein, the controller 26 according to the present embodiment performs a function of coupling a plurality of multimedia files and reproducing the coupled multimedia file as well as controlling general operations of the wireless communication terminal. That is, the controller 26 couples the plurality of the selected multimedia files into single integrated multimedia file using time information assigned to each of the multimedia files and reproduces the single integrated multimedia file.

In more specific, the controller 26 assigns time information to each of the multimedia files when the multimedia files are stored in the storing unit 22. That is, the time information is stored in a header of the multimedia file. Herein, the time information is used as a sequence number of the multimedia files to couple the plurality of the multimedia files to single integrated multimedia file. For example, the time information may be a time of capturing corresponding images or a time of storing the multimedia file. The sequence number may be automatically assigned to the multimedia files.

After assigning the sequence number, if the controller 26 receives a request signal of coupling and reproducing the multimedia files, the controller 26 decodes each of the multimedia files selected by a user and couples the plurality of the decoded multimedia files to the single integrated multimedia file according to the assigned time information. That is, raw data is created decoding the multimedia files and coupling the decoded multimedia files. The raw data of the coupled multimedia files is encoded to generate the single integrated multimedia file. Then, the integrated multimedia file is reproduced through the display unit 24 and the audio output unit 28, such as a LCD and a speaker.

As described above, it is preferable to couple the multimedia files and reproduce the single integrated multimedia file according to the selection of the user. That is, the wireless communication terminal according to the present embodiment may give a choice to reproduce each of the multimedia files independently, or to reproduce the single integrated multimedia file after coupling the plurality of the multimedia files to the single integrated multimedia file.

The storing unit 22 stores a driving program and a system program of the controller 26. Such a driving program and a system program may be stored in a read only memory (ROM) and may be deleted when it is required. The storing unit 22 also includes a random access memory (RAM) temporally storing data created while performing various programs. Furthermore, the storing unit 22 stores various multimedia files i.e., image files and programs for encoding and decoding. An encoding and a decoding of the multimedia files may be processed in hardware manner.

The input unit 23 may include a plurality of numeral keys or character keys, menu keys and functions keys for performing various tasks. The input unit 23 outputs key data to the controller 26 according to the external operation. The input unit 23 also receives the request signal of coupling and reproducing of the multimedia file from a user. That is, the request of selecting a plurality of multimedia files, coupling the selected multimedia files to single multimedia file and reproducing the single multimedia file are received through the input unit 23.

The display unit 24 is a display device such as a liquid crystal display (LCD). The display unit 24 generally displays a state of the wireless communication terminal or a progressing state of a program. That is, the general state of the wireless communication terminal and inputted information are displayed on the display unit 24. Furthermore, the display 24 displays images in response to the controller 26.

The image capturing unit 25 is a camera module having a lens. The image capturing unit 25 captures an image of an object in response to the controller 26. That is, still image or moving images of the object is obtained through the image capturing unit 25.

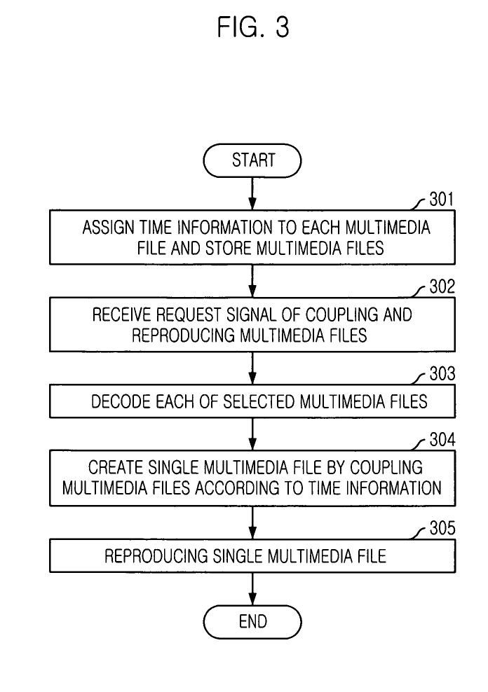

FIG. 3 is a flowchart showing a method of coupling and reproducing a plurality of multimedia files in accordance with a preferred embodiment of the present invention.

As shown in FIG. 3, the controller 26 assigns time information at each of the multimedia files and stores the multimedia files at the storing unit 22 at step S301. Herein, the time information may be a time of capturing corresponding image or a time of storing corresponding file.

The controller 26 receives a request of coupling and reproducing of the multimedia files through the input unit 23 at step S302, and decodes each of the selected multimedia files at step S303. The decoded multimedia files are coupled to single integrated multimedia file according to the assigned time information at step S304. That is, the plurality of the selected multimedia files is integrated as the single multimedia file in order to consecutively watch the plurality of selected multimedia files by reproducing the single multimedia file.

The controller 26 reproduces the created single multimedia file through the display unit 24 and the audio output unit 28.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

As described above, time information is assigned to a plurality of multimedia files, and the multimedia files are sequentially coupled according to the assigned time information. Therefore, a user can consecutively watch the plurality of the multimedia files by reproducing the single multimedia file and accordingly, the convenience of watching multimedia files is improved.

The present application contains subject matter related to Korean patent application No. KR 2005-0056529, filed in the Korean patent office on Jun. 28, 2005, the entire contents of which being incorporated herein by reference.

While the present invention has been described with respect to certain preferred embodiments, it will be apparent to those skilled in the art that various changes and modifications may be made without departing from the spirits and scope of the invention as defined in the following claims.

What is claimed is:

1. A wireless communication terminal comprising:
a storing unit for storing a plurality of multimedia files each of which has time information;
an input unit for receiving a request signal of coupling and reproducing of the plurality of multimedia files;
a controller for coupling the plurality of multimedia files to single integrated multimedia when the request signal of coupling and reproducing is received through the input unit; and
an output unit for outputting the single integrated multimedia file in response to the controller.

2. The wireless communication terminal as recited in claim 1, wherein the controller integrates the plurality of the multimedia files into the single integrated multimedia files according to the sequence number of the request signal of coupling and reproducing which is designated by a user.

3. The wireless communication terminal as recited in claim 1, wherein the controller assigns a time of capturing a corresponding image to a multimedia file as the time information.

4. The wireless communication terminal as recited in claim 1, wherein the controller assigns a time of storing each of the multimedia files to each of the multimedia files as the time information.

5. The wireless communication terminal as recited in claim 1, wherein the controller assigns a sequence number to each of the multimedia files as the time information.

6. A method of coupling and reproducing a plurality of multimedia files in a portable terminal, comprising:
inputting a request signal of coupling and reproducing a plurality of multimedia files;
coupling the plurality of multimedia files to single integrated multimedia file when the request signal of coupling and reproducing is received; and
reproducing the single integrated multimedia file.

7. The method as recited in claim 6, further comprising:
assigning time information to each multimedia file and storing the multimedia file with the time information.

8. The method as recited in claim 7, wherein in the step of coupling, the plurality of multimedia files are decoded and the decoded multimedia files are coupled according to the time information assigned to each of the multimedia files.

9. The method as recited in claim 7, wherein the time information is a time of capturing a corresponding image of the multimedia file.

10. The method as recited in claim 7, wherein the time information is a time of storing the multimedia file.

11. The method as recited in claim 7, wherein the time information is a sequence number of the request signal of coupling and reproducing which is designated by a user.
